(19) United States
(12) Patent Application Publication
(10) Pub. No.: US 2014/0252788 A1
(43) Pub. Date: Sep. 11, 2014

(54) FLOATING RETRIEVAL DEVICE

(71) Applicant: Bret Collin Draxten, Glendale, AZ (US)

(72) Inventor: Bret Collin Draxten, Glendale, AZ (US)

(21) Appl. No.: 13/787,864

(22) Filed: Mar. 7, 2013

(51) Int. Cl. B66F 19/00

(52) U.S. Cl. CPC B66F 19/00
USPC 294/211

(57) ABSTRACT

The present device is a floating retrieval device that can be either manually launched or automatically launched via a compression spring. The device is launched past a floating object. The device has wings that are deployed by releasing the wings. The wings also have an increased surface area due to the teeth on each wing. The device is then retrieved manually or by a reel. The device brings the item to be recovered to the user.

### BACKGROUND OF THE INVENTION

The use of devices to retrieve items that are not reachable in the water is not new to the art. Some examples of retrieval devices include U.S. Pat. No. 7,832,105 issued to Vogel on Nov. 16, 2010; entitled “Water Plant Removal Tool” which describes a manually operated cutting tool that is pulled across the surface of water to cut weeds. The device is inferior to the present device because it has to have an additional component added to become buoyant.

The current device floats and has fingers that extend both upward and downward to retrieve objects that are partially afloat, such as waterfowl. This prior art device also has cutting blades to cut vegetation whereas the present invention is for retrieval only.

Another prior art device that is used to retrieve vegetation from the bed of a lake is disclosed in U.S. Pat. No. 6,748,728 issued to Hay on Jun. 15, 2004, entitled “Rake System and Method for Removing Underwater Vegetation. This device is pulled along the lake bed to remove and retrieve weeds.

Another device for retrieving floating objects is U.S. Pat. No. 7,677,620 issued to Tasey on Mar. 16, 2010; entitled “Disc Retrieving Apparatus” discloses a telescopic handle rake to retrieve objects from water. The device is seriously limited, in that, you can only retrieve items within reach of the handle.

### THE INVENTION

The present device is a floating retrieval device. The device has a hollow, elongated shaft that has a near end and a distal end. The end of the shaft has a hollow handle attached thereto. This handle has a near end. The distal end has a latch mounted thereon. The latch has rotatably mounted thereon a pair of oppositely opposed retrieval wings. The retrieval wings are comprised of a shaft that has a plurality of elongated teeth mounted thereon. There is a retainer located near the near end of the handle, on the hollow shaft, and the retainer is configured to retain the retrieval wings while the retrieval wings are in a folded position.

There is also a cable. The cable is independently attached to each retrieval wing and the cable runs through the hollow elongated shaft and exits near the near end of the handle.

The present invention has no cutting device and is meant to recover floating items. The present device is deployed either manually or by spring compression and once it has hit the water a line deploys the wings and the device is retrieved bringing the floating item to the user.

It has been discovered that the present invention can recover items a considerable distance, giving it a greater utility over all prior art devices.

### BRIEF DESCRIPTION OF THE DRAWINGS

FIG. 1 shows a frontal view of the manual embodiment of the floating retrieval device showing it deployed.

FIG. 2 shows from the side showing the manual embodiment of the floating retrieval device closed ready to be launched.

FIG. 3 shows the manual embodiment of the floating retrieval device deployed.

FIG. 4 shows the latching system of the floating retrieval device.

FIG. 5 shows the spring latching system of the floating retrieval device.

FIG. 6 shows an auto launch handle of the device of FIG. 3.

FIG. 7 shows the auto launch embodiment of the floating retrieval device.

FIG. 8 shows the auto launch embodiment of the floating retrieval.

FIG. 9 is an anterior view of the device of FIG. 1.

FIG. 10 is a partial view of an alternative retrieval device which is a bobbin.

FIG. 11 shows a portion of the auto launch handle of the floating retrieval device with a cable retrieval device.

FIG. 12 shows an internal view along line A-A of the secondary handle.

### DETAILED DESCRIPTION OF THE DRAWINGS

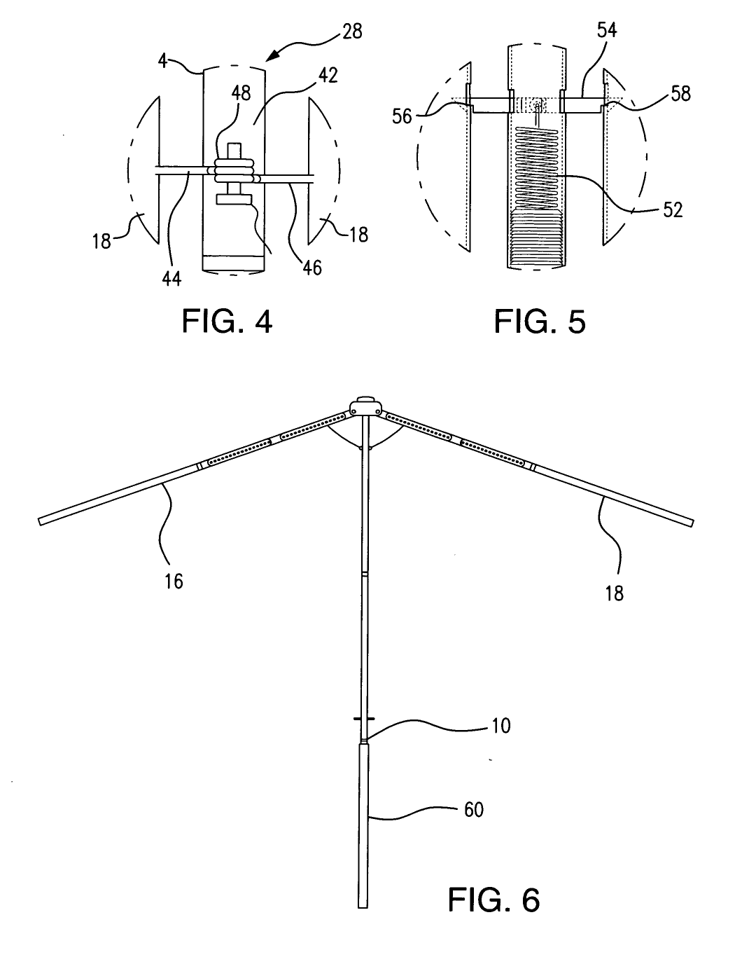

FIG. 1 shows the manual embodiment of the floating retrieval device 2, deployed. The hollow shaft 4 has a near end 6 and a distal end 8. The near end 6 of the hollow shaft 4 has a handle 10 attached to it. The near end 12 of handle 10 attached to the near end 6 of the hollow shaft 4. The near end 6 of hollow shaft 4 has a latch 28 for keeping the wings 16 and 18 in a stowed position. FIG. 4 provides a more detailed teaching of the latch 28.

At the distal end 8 of the hollow shaft 4 is a latch 14 that has wings 16 and 18 respectively attached thereto. The first wing 16 has a shaft portion 20 and this section supports teeth 22. The second wing 18 also had s shaft portion 24 that supports teeth 26. There is also a cable 30 that is threaded through the hollow shaft for the deployment of the wings 16 and 18.

This embodiment is designed to be manually thrown beyond the object that needs to be retrieved. The cable 30 is pulled which deploys the wings 16 and 18 and the cable 30 is manually retrieved bringing the desired object to the user.

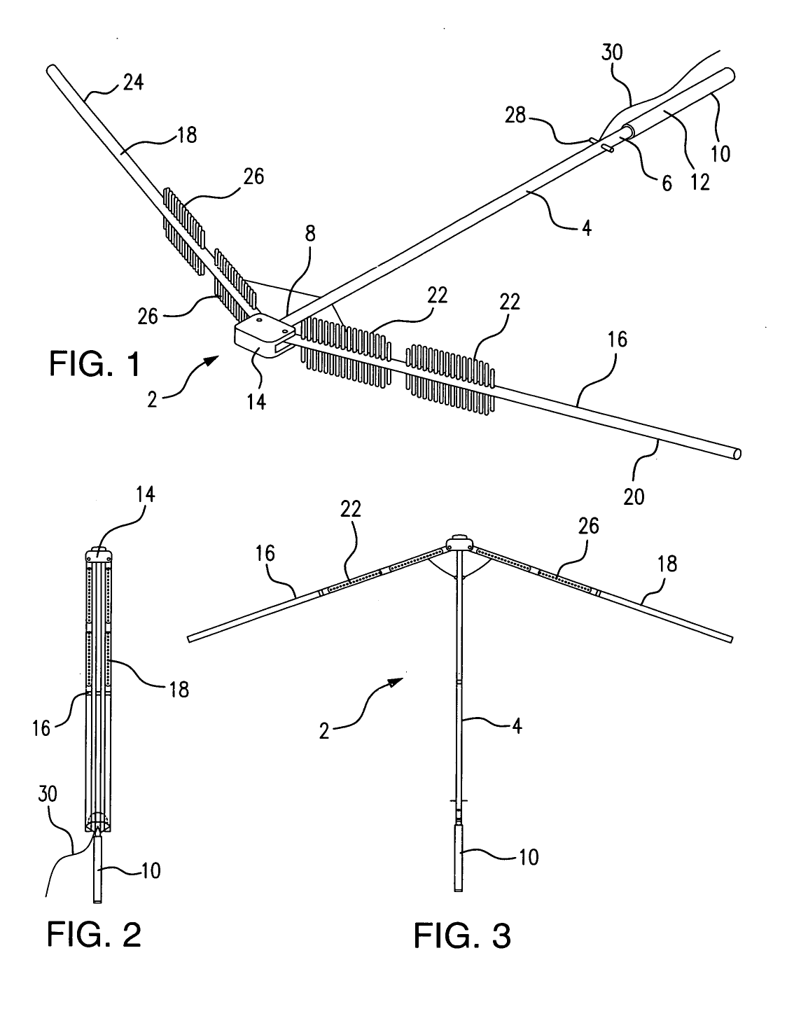

FIG. 2 shows the manual embodiment of the floating retrieval device 2 closed, ready to be launched. Here again with the wings 16 and 18 in the non-deployed or locked position the floating retrieval device 2 is ready to be launched or thrown. The latch 14 of the floating retrieval device is spring loaded. After the floating retrieval device has been thrown the cable 30 is pulled and the wings 16 and 18 move away from the hollow shaft 4 or deploy. At this point the cable 30 is retrieved bringing the desired item to the user.

FIG. 3 shows the manual embodiment of the floating retrieval device 2, deployed. At this point the floating retrieval device is ready to be retrieved. The cable 30 is pulled in or retrieved while the wings 16 and 18 with their respective teeth 22 and 24 rake the surface of the water grasping the item to be retrieved and returning it to the user. The user can simply latch the wings 16 and 18 down again and the floating retrieval device is ready to be launched or thrown again.

FIG. 4 shows the latching system 28 of the floating retrieval device 2. This embodiment allows the user to close the wings 16 and 18 with each fitted with a small eye bolt 44 and 46. There is also an eye bolt fitted to the hollow shaft 4. The wings 16 and 18 are brought together and pinned with the eye bolt pin 42. A line 50 is attached to the pin 42 and pulled out when the wings 16 and 18 need to be deployed.

FIG. 5 shows the spring latching system 52 of the floating retrieval device 2. This embodiment works in much the same way as that of FIG. 4. However, the wings 16 and 18 are held in place by a latch 54 that is attached to a spring 52 and a line 50. There are notches 56 and 58 respectively on the latch 54 that hold the wings to the latch 54. The line 50 is pulled compressing the spring 52 allowing the wings 16 and 18 to deploy.

FIG. 6 shows the auto launch embodiment of the floating retrieval device 2. This embodiment has the ability to launch automatically on demand. The handle 10 is forced into a secondary handle 60 that is capable of receiving the hollow handle, while compressing a spring 62 within the secondary handle 60. The hollow handle 10 is now locked within the secondary handle 60. There is also a trigger type mechanism 64 on the secondary handle that will click when the handle 10 is fully compressing the compression spring 62 and locked. The compression spring is not shown because it is within the secondary handle 60. (See FIG. 5).

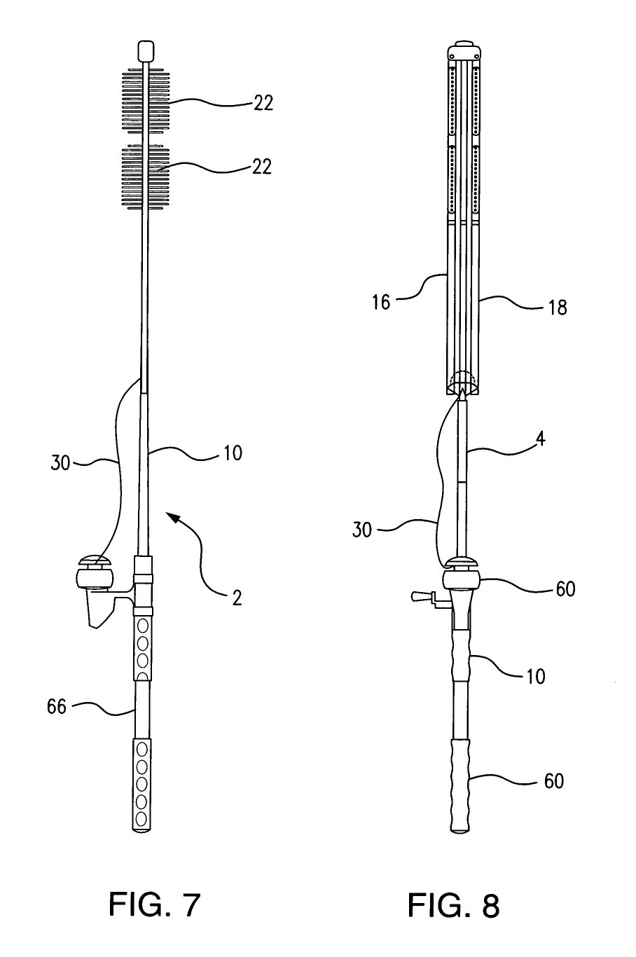

The user simply points the floating retrieving device and pulls the trigger 64. Then the user pulls the cable 30 to deploy the wings 16 and 18. Then the user can reel the cable 30 in retrieving the floating retrieval device 2. The secondary handle 60 is equipped with a fishing type reel 66 (See FIGS. 7 and 8) in this embodiment.

FIG. 7 shows the auto launch embodiment of the floating retrieval device 2 from the side. Here the fishing reel 66 is shown. It is also clear how the hollow handle 10 fits into the secondary handle 60. The teeth 22 are also shown.

FIG. 8 shows the auto launch embodiment of the floating retrieval device 2 from the front. Here the floating retrieval device 2 is not deployed. The hollow handle 10 of the hollow shaft 4 is inserted into the secondary handle 66 with a fishing reel 66 present. The fishing reel 66 has cable 30 attached for the deployment of the wings 16 and 18.

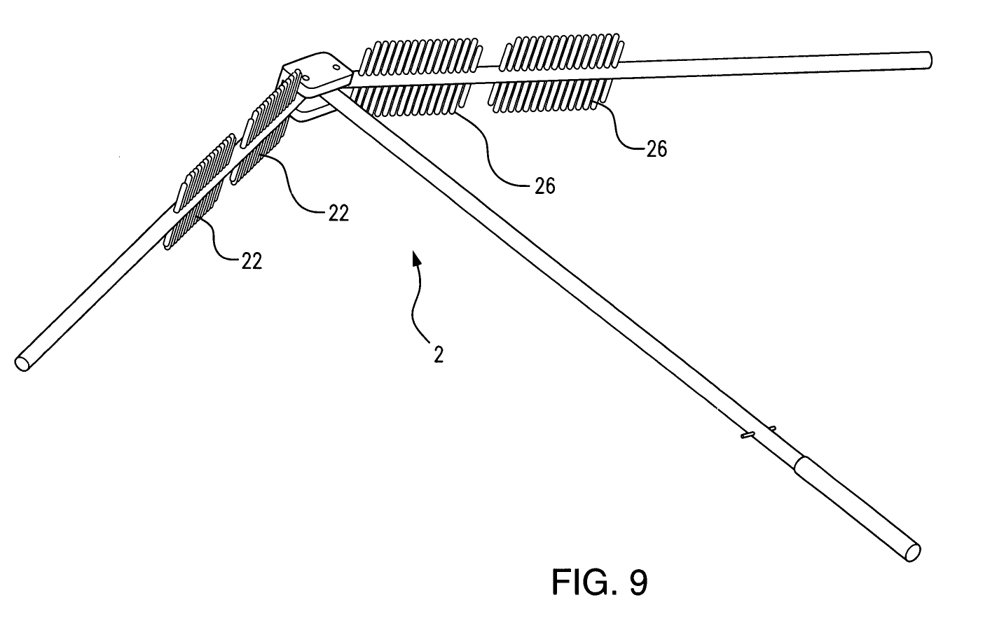

FIG. 9 shows the manual launch embodiment of the floating retrieval device 2. This shows the significance of the teeth 22 and 24 in the retrieval process. It has been discovered that the teeth 22 and 24 add extra area to the floating retrieval device 2 giving it greater utility over any other prior art devices.

FIG. 10 shows the auto launch handle of the floating retrieval device 2 with a cable retrieval device 68. This Figure teaches another embodiment where instead of a fishing reel 66 for retrieval of the cable 30 the secondary handle 60 has a bobbin type retriever 68. This allows the cable to free spool off of the bobbin and then it must be rewound in preparation to launch or throw again depending on if you are operating the manual or auto launch embodiments.

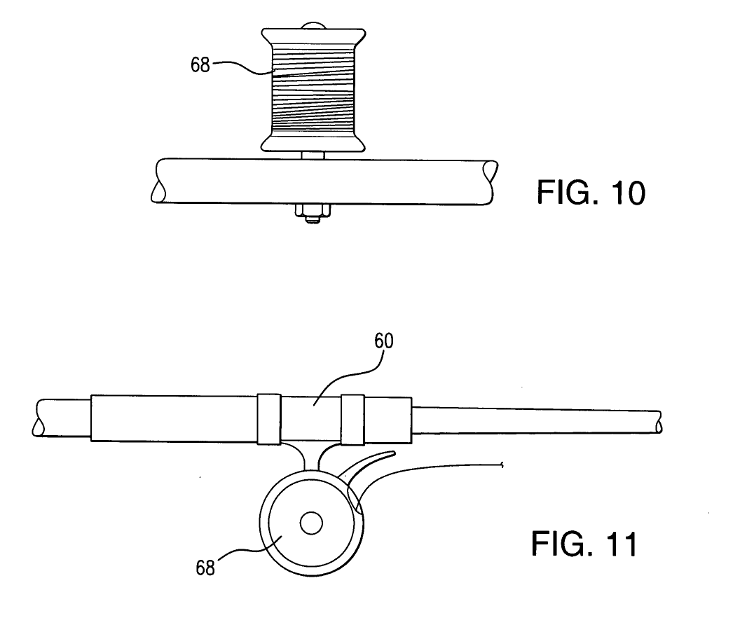

FIG. 11 shows the auto launch handle of the floating retrieval device 2 with a cable retrieval device 70. This embodiment has a reel that incorporates a coil spring drive device that drives the retrieval. Simply pull the trigger and the coil spring driven reel automatically brings the line in and the floating retrieval device 2 is ready to be used again.

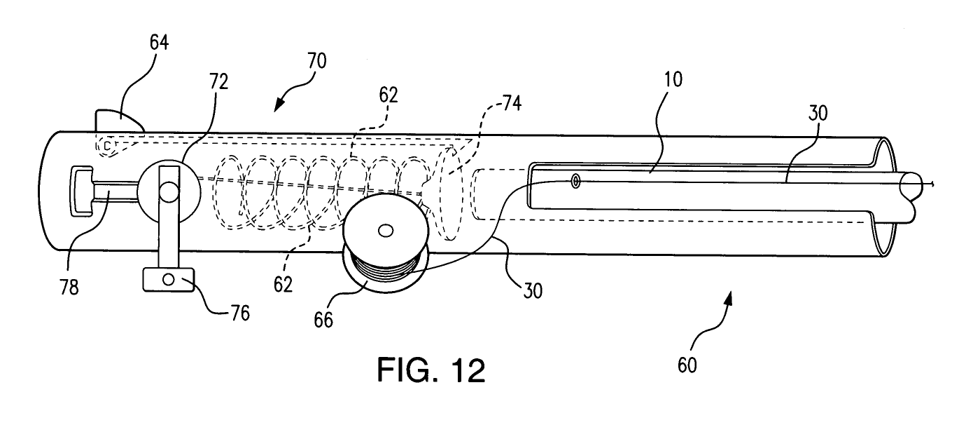

FIG. 12 shows another embodiment of the floating retrieval device 2 has a secondary handle 60 that contains a compression spring 62 within it. When the handle 10 of the floating retrieval device 2 is forced into the secondary handle it compresses the spring 62 and then locks within the secondary handle 60 to be released by a trigger 64. The cable 30 is once again pulled deploying the wings 16 and 18 (not shown) and the floating retrieval device 2 is either pulled in or reeled in. Here the reel 68 is manual and is cranked to retrieve the wings 16 and 18. This embodiment has a crank 70, a spring reel 72 and a spring compression device 74. The spring reel 72 is cranked and the spring compression device 74 retracts the spring 62 in preparation for launch. When the spring 62 is fully compressed the trigger 64 locks it into place. The handle 76 of the crank 70 folds down then inserts into the recess 78 of the handle 60. The trigger 64 will launch the device 2 on command. The wings 16 and 18 are retrieved and the spring 62 is compressed allowing the device 2 to be readied for use again. The secondary handle 60 has a groove 80 in its exterior that allows the eye bolt 48 of the hollow shaft 4 to pass when launched.

In summary, the floating retrieval device 2 is a hand held device that can be thrown or launched in an effort to retrieve or recover items floating at a distance. One embodiment is simply thrown and the cable 30 is pulled deploying the wings 16 and 18 and the floating retrieval device is recovered either manually or with a reeling device of varying sorts via cable 30.

What is claimed is:

1. A floating retrieval device, said device having a hollow, elongated shaft having a near end and a distal end;
said near end of said shaft having a hollow handle attached thereto, said handle having a near end;
said distal end having a latch mounted thereon, said latch having rotatably mounted thereto, a pair of oppositely opposed retrieval wings, said retrieval wings comprised of a shaft having a plurality of elongated teeth mounted thereon;
a retainer located near the near end of the handle, on the hollow shaft, and said retainer configured to retain said retrieval wings while said retrieval wings are in a folded position;
a cable, said cable being independently attached to each retrieval wing and said cable running through the hollow elongated shaft and exiting near the near end of the handle.

2. A floating retrieval device, said device having an elongated shaft having a near end and a distal end;
said near end of said shaft having a hollow handle attached thereto, said handle having a near end, there being attached to the handle, a retrieval device;
said distal end having a latch mounted thereon, said latch having rotatable mounted thereto, a pair of oppositely opposed retrieval wings, said retrieval wings comprised of a shaft having a plurality of elongated teeth mounted thereon;
a retainer located near the near end of the handle, on the hollow shaft, and said retainer configured to retain said retrieval wings while said retrieval wings are in a folded position;
a cable, said cable being independently attached to each retrieval wing, the opposite end of said cable being attached to said retrieval device;
a compressible spring mounted on the elongated shaft, one end of said spring being attached to the handle, near the near end of the handle, and the opposite end of said spring being adjacent to a middle point of the elongated shaft, there being a trigger release suppressing said spring when compressed, said trigger release being mounted on said elongated shaft adjacent to said retrieval device.

3. The device as claimed in claim 1 wherein the elongated shaft is comprised of segments to be joined together to form the elongated shaft.

4. The device as claimed in claim 3 wherein the segments are threaded on the ends thereof.

5. The device as claimed in claim 2 wherein the elongated shaft is comprised of segments to be joined together to form the elongated shaft.

6. The device as claimed in claim 5 wherein the segments are threaded on the ends thereof.

7. The device as claimed in claim 2 wherein the retrieval device is a fishing reel.

8. The device as claimed in claim 2 wherein the retrieval device is a bobbin.

9. The device as claimed in claim 1 wherein the device is manufactured from aluminum.

10. The device as claimed in claim 2 wherein the device is manufactured from aluminum.

11. The device as claimed in claim 1 wherein the device is manufactured from plastic.

12. The device as claimed in claim 2 wherein the device is manufactured from plastic.
